(19) United States
(12) Patent Application Publication
(10) Pub. No.: US 2005/0257848 A1
(43) Pub. Date: Nov. 24, 2005

(54) Plastic lined steel pipe with end corrosive protection core and method for producing same

(76) Inventors: Shinichi Funatsu, Kimitsu-shi (JP); Hiroyuki Mimura, Kimitsu-shi (JP); Yoshihisa Kariyazono, Kimitsu-shi (JP); Eiji Takata, Inabe-shi (JP); Manish Mathur, Kuwana-shi (JP); Tetsumi Kondoh, Tokyo (JP); Chikaomi Matsuo, Tokyo (JP); Takeshi Miyama, Tokyo (JP)

Correspondence Address: Kenyon & Kenyon, One Broadway, New York, NY, 10004, US

(21) Appl. No.: 11/137,654

(22) Filed: May 24, 2005

(30) Foreign Application Priority Data
May 24, 2004 (JP) 2004-153736(PAT.
Apr. 14, 2005 (JP) 2005-117248(PAT.

(51) Int. Cl. F16L 9/14

(52) U.S. Cl. 138/146; 138/109

(57) ABSTRACT

A plastic lined pipe with an end corrosive protection core used for snow removal, water supply, air-conditioning, firefighting, drainage, and other piping etc. and a method of production of the same, more particularly a plastic lined pipe with an end corrosive protection core, used connected by a coupling not having an end corrosive protection function, having an adhesive layer on an inner surface of a steel pipe or a steel pipe galvanized on its outer surface, having a polyolefin plastic layer or cross-linked polyolefin plastic layer on its further inner side, the steel pipe given substrate treatment on its inner surface in advance, the substrate treatment comprising forming a phosphate chemical conversion coating treated for grain refinement, and provided at its end with a corrosive protection core formed by a cylindrical part having dimensions and rigidity enabling strong fitting to the end inner surface of the plastic lined steel pipe and a flange part having a shape and rigidity enabling attachment, then close fitting to the end while completely covering the end face of the plastic lined steel pipe, the outer surface of the cylindrical part being provided with circumferential grooves, the material being a high corrosion resistance metal, and the inner surface of the flange part of the corrosive protection core having a rubber ring closely fit to it, and a method of production of the same.

### BACKGROUND OF THE INVENTION

1. Field of the Invention

The present invention relates to a plastic lined steel pipe with an end corrosive protection core used for piping etc. for snow melting, water supply, air-conditioning, firefighting, drainage, etc. when an end corrosive protection coupling cannot be used and a method for producing the same, in more detail relates to a plastic lined steel pipe with an end corrosive protection core excellent in bonding between the steel pipe and the end inner surface plastic lining layer and fastenability of the corrosive protection core and end inner surface plastic lining layer over a long period even when used outdoors at cold locations where the drop in air temperature in the winter season causes a shrinkage and large peeling force of the inner surface plastic lining layer and further the level of the air temperature causes the inner surface plastic lining layer to expand and contract and therefore causes a large easing of stress and a drop in the fitting strength of the corrosive protection core and a method for producing the same.

2. Description of the Related Art

As the material of piping for transporting water etc., other than steel pipes such as forged steel pipes and seam-welded steel pipes, polyvinyl chloride, polyethylene, polypropylene, polybutene, and other thermoplastic plastic pipes are being used. Steel pipes have larger mechanical strengths in comparison with these plastic pipes, therefore have higher shock resistance at the time of installation and have excellent compression resistance even when buried under heavy traffic roads. Even when the temperature of the transported fluid is high, the pipes are sufficiently large and excellent in compression strength when compared with plastic pipes and hard to burn unlike plastic pipes, so will not burn by fire even when used for indoor purposes.

However, in applications requiring prevention of clouding of the fluid and the prevention of clogging of the pipeline due to the corrosion of the steel, use is made of plastic pipe not subject to corrosion. As a piping material having the merits of both, a composite pipe of plastic and steel prevented from corrosion by inserting a plastic pipe into the inner surface of a steel pipe is known. For example, as a water pipe and drainage pipe, a composite pipe of steel and a soft polyvinyl chloride making good use of cheap polyvinyl chloride is being widely used, while as a hot water pipe, a composite pipe of steel and a hard polyvinyl chloride is being widely used.

When using a polyvinyl chloride material, however, there is also the problem that dioxins are produced when incinerating the remaining pieces of composite pipes produced in on-site piping work. Accordingly, as the composite pipes used for water pipes, hot water pipes, drainage pipes, etc., pipes not using polyvinyl chloride have been desired.

Therefore, Japanese Unexamined Patent

Publication (Kokai) No. 2003-294174 and International Publication WO2004-11231 take note of the polyolefin resin or cross-linked polyolefin resin free from the problem of production of dioxins instead of polyvinyl chloride and disclose plastic lined steel pipe used for water supply, hot water supply, air-conditioning, firefighting, drainage, etc. excellent in bonding of the steel pipe and inner surface plastic lining layer over a long time by drawing the steel pipe to line the inner surface while leaving an expansion force so that the polyolefin plastic pipe or cross-linked polyolefin plastic pipe tries to become larger in outside diameter than the inside diameter of the steel pipe and providing between the steel pipe and polyolefin plastic pipe or cross-linked polyolefin plastic pipe an adhesive layer and chemical conversion coating and in accordance with need providing an epoxy primer layer.

However, when it is necessary to use a coupling not having an end corrosive protection function such as a sprinkler-equipped H-coupling used for example for snow removing pipes, iron is exposed at the end face of the steel pipe and therefore corrosion proceeds and further the bonded interface of the steel pipe and inner surface plastic lining layer deteriorates and the bond strength weakens, so the end inner surface plastic lining layer easily peels off from the steel pipe.

Therefore, it was learned that it becomes necessary to attach a corrosive protection core to the end to cover the end face of the steelpipe to prevent corrosion of the iron, but in outdoor use in cold regions, the drop in air temperature in the winter season causes large shrinkage and peeling force of the inner surface plastic lining layer and further the level of the air temperature causes the inner surface plastic lining layer to expand and contract so that the stress is greatly eased and the fitting strength of the corrosive protection core drops and that in this case, the chemical conversion coating cannot withstand the strinkage and peeling force of the inner surface plastic lining layer and ends up breaking, the plastic lining layer at the inner surface of the end peels off, and the flowing water causes detachment of the corrosive protection core from the end.

Further, if suppressing the drop in fitting strength of the corrosive protection core by having the fitting strength become larger by making the outside diameter of the cylindrical part to be fit into the end inner surface of the plastic lined steel pipe larger, there is the problem that when the rise in air temperature in the summer season causes the inner surface plastic lining layer to expand, the corrosive protection core ends up being pushed out so invites a drop in the end corrosive protection function and that the structure has to be made thicker so that the cylindrical part does not deform, so the flow path shrinks and a pressure loss ends up being caused.

### SUMMARY OF THE INVENTION

In consideration with the above problems, the present invention provides a plastic lined steel pipe with an end corrosive protection core used for piping etc. for snow melting, water supply, air-conditioning, firefighting, drainage, etc. when an end corrosive protection coupling cannot be used which is excellent in bonding between the steel pipe and the end inner surface plastic lining layer and fastenability of the corrosive protection core and end inner surface plastic lining layer over a long period even when used outdoors at cold locations where the drop in air temperature in the winter season causes a shrinkage and large peeling force of the inner surface plastic lining layer and further the level of the air temperature causes the inner surface plastic lining layer to expand and contract and therefore causes a large easing of stress and a drop in the fitting strength of the corrosive protection core and a method for producing the same.

The inventors discovered a way to maintain the bonding between the steel pipe and the end inner surface plastic lining layer and fastenability of the corrosive protection core and end inner surface plastic lining layer over a long period. That is, in outdoor use in cold regions, the drop in air temperature in the winter season causes large shrinkage and peeling force of the inner surface plastic lining layer and further the level of the air temperature causes the inner surface plastic lining layer to expand and contract so that the stress is greatly eased and the fitting strength of the corrosive protection core drops. In this case, the chemical conversion coating cannot withstand the strinkage and peeling force of the inner surface plastic lining layer and ends up breaking, the plastic lining layer at the inner surface of the end peels off, and the flowing water causes detachment of the corrosive protection core from the end. Further, if suppressing the drop in fitting strength of the corrosive protection core by having the fitting strength become larger by making the outside diameter of the cylindrical part to be fit into the end inner surface of the plastic lined steel pipe larger, there is the problem that when the rise in air temperature in the summer season causes the inner surface plastic lining layer to expand, the corrosive protection core ends up being pushed out so invites a drop in the end corrosive protection function and that the structure has to be made thicker so that the cylindrical part does not deform, so the flow path shrinks and a pressure loss ends up being caused.

The inventors discovered that by treating the steel pipe for substrate treatment by refining the grains and providing a phosphate chemical conversion coating strengthened in bond strength so as to prevent the chemical conversion coating from failing to withstand the increase in shrinkage and peeling force of the inner surface plastic lining layer due to the drop in air temperature in the winter season in outdoor use in cold regions and ending up breaking and the plastic lining layer at the inner surface of the end from peeling off, providing circumferential grooves at the outer surface of the cylindrical part of the corrosive protection core so as to absorb the expansion of the inner surface plastic lining layer due to the rise in air temperature in the summer season and prevent the corrosive protection core from ending up being pushed out, and having the expanded inner surface plastic lining layer project out and constrain the corrosive protection core so as to prevent the flow of water from causing the corrosive protection core from detaching from the end even when the level of the air temperature causes the inner surface plastic lining layer to expand and contract and therefore the stress to be greatly eased and the fitting strength of the corrosive protection core drops, a plastic lined steel pipe with an end corrosive protection core used for piping etc. for snow melting, water supply, air-conditioning, firefighting, drainage, etc. when an end corrosive protection coupling cannot be used which is excellent in bonding between the steel pipe and the end inner surface plastic lining layer and fastenability of the corrosive protection core and end inner surface plastic lining layer over a long period becomes possible. The gist thereof is as follows:
(1) A plastic lined steel pipe with an end corrosive protection core used connected by a coupling not having an end corrosive protection function, characterized by having an adhesive layer on an inner surface of a steel pipe or a steel pipe galvanized on its outer surface, having a polyolefin plastic layer or cross-linked polyolefin plastic layer on its further inner side, said steel pipe being a steel pipe given substrate treatment on its inner surface in advance, said substrate treatment comprising forming a phosphate chemical conversion coating treated for grain refinement, and provided with a corrosive protection core at the end.
(2) A plastic lined steel pipe with an end corrosive protection core as set forth in the above (1), wherein said corrosive protection core is formed by a cylindrical part having dimensions and rigidity enabling strong fitting to the end inner surface of the plastic lined steel pipe and a flange part having a shape and rigidity enabling attachment, then close fitting to the end while completely covering the end face of the plastic lined steel pipe, the outer surface of the cylindrical part being provided with circumferential grooves.
(3) A plastic lined steel pipe as set forth in the above (1) or (2) wherein the material of said corrosive protection core is a high corrosion resistance metal, and the inner surface of the flange part of the corrosive protection core has a rubber ring closely fit to it.
(4) A plastic lined steel pipe with an end corrosive protection core as set forth in any one of the above (1) to (3), wherein an epoxy primer layer is provided between said steel pipe and said adhesive layer.
(5) A plastic lined steel pipe with an end corrosive protection core as set forth in any one of the above (1) to (4), wherein a primary anti-rust coating, a zinc rich paint coating, a metal flame sprayed coating, or a polyolefin coating is provided on the outer surface of said plastic lined steel pipe instead of galvanization.
(6) A method for producing a plastic lined steel pipe as set forth in any one of the above (1) to (5), comprising, when producing said plastic lined steel pipe, applying substrate treatment to a steel pipe or applying substrate treatment to a steel pipe, then applying an epoxy primer layer, inserting a polyolefin plastic pipe or cross-linked polyolefin plastic pipe having an outside diameter smaller than the inside diameter of the steel pipe and having an adhesive layer on its outer surface into said steel pipe, drawing the steel pipe so as to make the polyolefin plastic pipe or cross-linked polyolefin plastic pipe come in close contact with the inner surface of the steel pipe, then heating the result at a temperature not less than a melt end temperature of the adhesive layer and less than a melt start temperature of the polyolefin plastic pipe or cross-linked polyolefin plastic pipe.
(7) A method for producing a plastic lined pipe with an end corrosive protection core as set forth in the above (6) further comprising, when drawing said steel pipe, drawing the steel pipe so that the outside diameter of the polyolefin plastic pipe or cross-linked polyolefin plastic pipe is reduced by 0.5 to 10%.

### BRIEF DESCRIPTION OF THE DRAWINGS

FIG. 1 shows an example of a cross-section of a corrosive protection core of the present invention.

FIG. 2 shows an example of a cross-sectional shape of a groove of a corrosive protection core of the present invention.

FIG. 3 shows another example of a cross-sectional shape of a groove of a corrosive protection core of the present invention.

FIG. 4 shows another example of a cross-sectional shape of a groove of a corrosive protection core of the present invention.

FIG. 5 shows an example of the cross-section in the case of attaching the corrosive protection core of the present invention to the end of a plastic lined steel pipe.

### DESCRIPTION OF THE PREFERRED EMBODIMENTS

When producing the plastic lined pipe of the present invention, first the steel pipe is degreased and pickled or blasted to clean it. This steel pipe may be treated on its outer surface with hot dip galvanization or other plating. One with an outside diameter of about 10 to 2000 mm, usually about 20 to 170 mm, is used.

Next, the inventors discovered that if applying, as the substrate treatment of the steel pipe, a phosphate chemical conversion coating treated for grain refinement to reinforce its bond strength, even if a drop in air temperature in the winter season in outdoor use in cold regions causes the shrinkage and peeling force of the inner surface plastic lining layer to become larger, the chemical conversion coating will never fail to withstand this and end up breaking and the plastic lining layer at the end inner surface will never end up peeling off. Further, they discovered that the finer the grains of the phosphate of the chemical conversion coating, the more improved the bond strength. As the chemical conversion solution, a mixture comprised of for example phosphoric acid, nitric acid, zinc oxide, calcium carbonate, and water and adjusted in pH by sodium hydroxide (calcium-modified zinc phosphate treatment solution) is used. Calcium-modified zinc phosphate is excellent in heat resistance, so is preferred for the present invention. The amounts of addition of these are 8 to 15 g/L as phosphoric acid ions, 30 to 60 g/L as nitric acid ions, 2 to 4 g/L as zinc ions, 5 to 10 g/L as calcium ions. If the pH is in the range of 2.0 to 2.5, a good waterproof bonding is obtained. As a representative calcium-modified zinc phosphate treatment solution corresponding to the above composition, there is Palbond P (made by Nihon Parkerizing Co. Ltd.)

In the coating of the chemical conversion coating, the steel pipe may be coated with the above chemical conversion solution by dipping, injection into the steel pipe, or spraying, then rinsed with cold water and hot water and heated and dried by hot air heating, high frequency induction heating, etc. The amount of deposition of this chemical conversion coating is preferably about 1 to 10 g/m². If the deposition amount thereof is less than 1 g/m², the chemical conversion coating will not completely cover the iron surface and therefore the waterproof bond strength of the inner surface plastic lining layer will drop. Further, if the amount of deposition is over 10 g/m², brittle secondary crystal grains will grow in the chemical conversion coating, so the bond strength or waterproof bond strength of the inner surface plastic lining layer will be lowered.

The grain refinement is carried out, before coating the chemical conversion coating, by dip coating, insertion coating, or spray coating the steel pipe with for example a treatment solution obtained by dispersing titanium colloid in water in a range of from 1 to 5 g/L (as representative example, there is Prepalene Z (made by Nihon Parkerizing Co. Ltd.)) and/or adding to the above chemical conversion solution for example basic nickel carbonate as the nickel ions in a range of from 0.2 to 1.0 g/L. The titanium or nickel forms cores for the precipitation of crystal grains of the phosphate and densely adhere to the iron surface to refine the grains, therefore the contact area between the crystal grains and the iron increases and the bond strength is improved. If not performing the grain refinement, crystal grains having a size of over 10 μm will be generated, but if performing the grain refinement, the crystal grains will be refined to a size of 10 μm or less, therefore the bond strength is improved three-fold or more. If the amounts added are less than the lower limits, the effect of the grain refinement will be lowered, while if over the upper limits, the economicalness will deteriorate.

After this, a polyolefin plastic pipe or cross-linked polyolefin plastic pipe having an outside diameter smaller than the inside diameter of the steel pipe and longer than the length of the steel pipe is inserted into the steel pipe, the steel pipe is roll drawn, strike drawn, or die drawn so that the outside diameter of the polyolefin plastic pipe or cross-linked polyolefin plastic pipe is reduced by 0.5 to 10% to thereby make the polyolefin plastic pipe or cross-linked polyolefin plastic pipe closely contact the inner surface of the steel pipe. If the reduction ratio of this polyolefin plastic pipe or cross-linked polyolefin plastic pipe is less than 0.5%, the expansion force making the outside diameter the polyolefin plastic pipe or cross-linked polyolefin plastic pipe larger than the inside diameter of the steel pipe becomes smaller, so the force causing close contact with the inner surface of the steel pipe will be weakened and the bond strength of the inner surface plastic lining layer will be lowered. If the reduction ratio of the polyolefin plastic pipe or cross-linked polyolefin plastic pipe is over 10%, the polyolefin plastic pipe or cross-linked polyolefin plastic pipe will deform, so the bonding with the inner surface of the steel pipe will be degraded. Further, a corrosive protection core is attached to the end to finish the plastic lined steel pipe with a corrosive protection core of the present invention.

As the polyolefin resin, use is made of an ethylene homopolymer or an ethylene/α-olefin copolymer obtained by copolymerizing ethylene and propylene, 1-butene, 1-hexene, 1-octene, or another α-olefin or a mixture of the same into which additives such as an antioxidant, UV absorbent, fire retardant, pigment, filler, lubricant, antistatic agent and other resins are mixed according to need within a range not impairing the performance of the present invention.

As the cross-linked polyolefin resin, use is made of a polyolefin resin which is cross-linked by using a radical generator or a silane-modified polyolefin resin which is water cross-linked (silane cross-linked). As the radical generator, use is made of an organic peroxide such as dicumyl peroxide, benzoyl peroxide, di-t-butyl peroxide, or 2,5-dimethyl-2,5-di(t-butylperoxy)hexane. Further, other than the above organic peroxides, use can be also made of an azo compound such as azoisobutylonitrile. The silane modification is carried out by graft reacting an ethylenic unsaturated silane compound with the polyolefin resin in the presence of the radical generator. Here, the ethylenic unsaturated silane compound is represented by the following general formula.
RSiR′ₙY₃₋ₙ
(wherein, R represents an ethylenic unsaturated hydrocarbon group or hydrocarbon oxy group, R′ represents an aliphatic saturated hydrocarbon group, Y represents an organic group which can be hydrolyzed, and n represents 0 to 2).

Specifically, vinyl trimethoxysilane, vinyl triethoxysilane, vinyl triacetoxysilane, etc. is used. This silane modification may be carried out in advance by an extruder etc. or may be carried out by at the time of shaping by charging the stock ingredients from a hopper and performing it at the kneading portion of the shaping machine. The cross-linking reaction is carried out by heat treatment, water treatment, etc. after the extrusion and/or shaping. In the case of a silane-modified polyolefin resin, in order to improve the cross-linking speed, a silanol condensation catalyst is preferably used together. This may be mixed in at the time of the shaping or coated after the shaping. As the silanol condensation catalyst, dibutyl tin dilaurate, dioctyl tin dilaurate, cobalt naphthenate, toluene sulfonic acid, etc. can be used. The cross-linked polyolefin resin used in the present invention may have added to it, within a range not impairing the performance of the present invention, an additive such as an antioxidant, UV absorbent, fire retardant, pigment, filler, lubricant, or antistatic agent or other resin according to need.

As the method of preparation of the polyolefin plastic pipe or cross-linked polyolefin plastic pipe used in the present invention, a resin is extruded in the form of a pipe using an extruder or the like from a round die having an outside diameter smaller than the inside diameter of the steel pipe to be lined, then cooled to fix its shape. The thickness of this polyolefin plastic pipe or cross-linked polyolefin plastic pipe can be freely set according to need. It is not particularly limited, but usually a pipe of a thickness of 0.3 mm to 10 mm, preferably 0.5 mm to 5 mm, is used. Further, in order to improve the bond strength with the adhesive layer, after shaping the plastic pipe, according to need, the outer surface is coated by a commercially available primer, oxidized, or roughened.

A steel pipe and a polyolefin plastic pipe or cross-linked polyolefin plastic pipe do not have much bonding, so an adhesive layer is desirably provided between them. Especially, it was found that by forming the adhesive layer by a material comprised of one or two or more of a maleic anhydride-modified polyolefin, itaconic anhydride-modified polyolefin, ethylene/maleic anhydride copolymer, ethylene/maleic anhydride/acrylate copolymer, ethylene/maleic anhydride/acrylate ester copolymer, ethylene/acrylate copolymer, ethylene/acrylate ester copolymer, ethylene/methacrylate copolymer, ethylene/vinyl acetate copolymer, and ionomer and having a melt end temperature less than the melt start temperature of the polyolefin plastic pipe or cross-linked polyolefin plastic pipe and over the usage temperature, a bond strength far superior to that of other materials is manifested. As the polyolefin of an adhesive layer made of a maleic anhydride-modified polyolefin, use is made of for example a low crystallinity ethylene-based copolymer having a melt end temperature of 100° C. If the melt end temperature is not less than the melt start temperature of the polyolefin plastic pipe or cross-linked polyolefin plastic pipe, it is necessary to perform heating at a temperature not less than the melt start temperature of the polyolefin plastic pipe or cross-linked polyolefin plastic pipe for manifesting the bond strength, therefore the polyolefin plastic pipe or cross-linked polyolefin plastic pipe will soften, the expansion force will be lost, and, in the cooling step, a contraction force will be caused by recrystallization, the force for close adhesion to the inner surface of the steel pipe will be weakened, and the bond strength of the inner surface plastic liner layer will fall. Further, if the melt end temperature is not more than the usage temperature of the polyolefin plastic pipe or cross-linked polyolefin plastic pipe, the adhesive layer will completely melt during use, so the bond strength of the inner surface plastic lining layer will be lowered.

The adhesive layer is coated by coextruding the adhesive layer onto the outer surface of the polyolefin plastic pipe or cross-linked polyolefin plastic pipe at the time of shaping the polyolefin plastic pipe or cross-linked polyolefin plastic pipe using a two-layer round die having an outside diameter smaller than the inside diameter of the steel pipe to be lined or by coextruding the adhesive layer after shaping the polyolefin plastic pipe or cross-linked polyolefin plastic pipe by using a round die or T-die. Further, in order to manifest the bond strength, after roll drawing, strike drawing, or die drawing the steel pipe, the pipe is heated at a temperature not less than the melt end temperature of the adhesive layer and less than the melt start temperature of the polyolefin plastic pipe or cross-linked polyolefin plastic pipe by hot air heating, high frequency induction heating, etc. If the heating temperature is less than the melt end temperature of the adhesive layer, the adhesive layer will not be completely melted, so the bond strength of the inner surface plastic lining layer will not be manifested. Further, if the heating temperature is the melt start temperature of the polyolefin plastic pipe or cross-linked polyolefin plastic pipe or more, the polyolefin plastic pipe or cross-linked polyolefin plastic pipe will soften, the expansion force will be lost, and, in the cooling step, a contraction force will be caused by recrystallization, the force for close adhesion to the inner surface of the steel pipe will be weakened, and the bond strength of the inner surface plastic liner layer will fall. The thickness of this adhesive layer can be freely set according to need. It is not particularly limited, but usually a thickness of 1 μm to 3 mm, preferably 10 μm to 1.5 mm, is used.

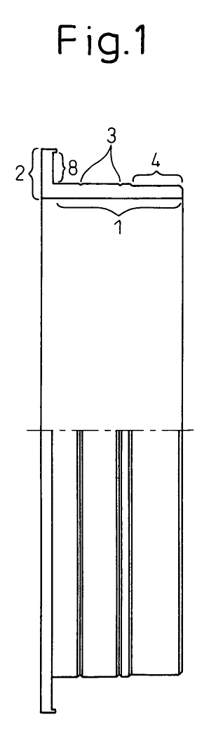

An example of the corrosive protection core used in the present invention is shown in the cross-sectional view of FIG. 1. The corrosive protection core is formed by a cylindrical part 1 to be fit into the end inner surface of the plastic lined steel pipe and a flange part 2 covering the end face of the plastic lined steel pipe. The outer surface of the cylindrical part 1 is provided circumferentially with grooves 3. The dimensions of the cylindrical part 1 may be freely set in accordance with need. They are not particularly limited, but have to be dimensions enabling a strong fit in the end inner surface of the plastic lined steel pipe. Therefore, the core has to have a rigidity enough so as not to deform after attachment to the pipe end. Note that if providing the front end of the cylindrical part 1 with a taper or a guide 4 of an outside diameter smaller than the inside diameter of the plastic lined steel pipe, the corrosive protection core can be easily attached to the pipe end.

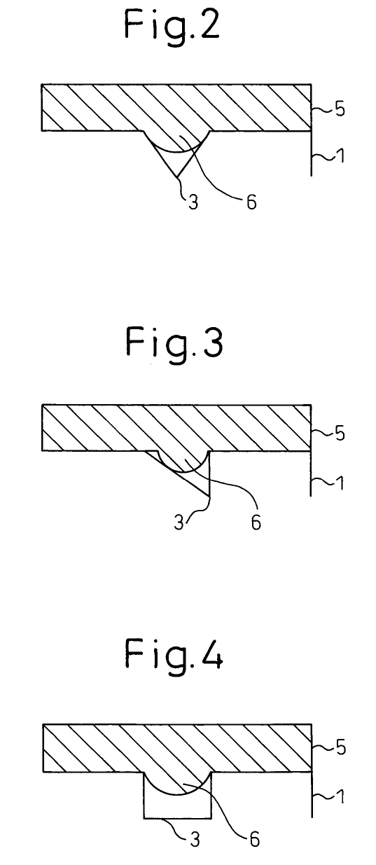

Further, the outer surface of the cylindrical part 1 is provided circumferentially with grooves 3, but if their cross-sectional shapes are for example V-shapes or recessed shapes such as shown in FIGS. 2 to 4, the grooves catch with the projections 6 formed due to expansion of the inner surface plastic lining layer 5 due to the rise in air temperature in the summer season, so a large restraining force is obtained. If considering the formation of the projections 6 and the maintenance of the restraining force, it is necessary that the part not deform after attachment to the pipe end. Further, the shape of the flange part 2 may also be freely set in accordance with need. It is not particularly limited, but must be a shape enabling the end face of the plastic lined steel pipe to be completely covered and closely contacted. Therefore, the part must have a rigidity not deforming after attachment to the pipe end. In this way, the corrosive protection core requires enough rigidity not to deform after attachment to the pipe end, so the material used should be for example stainless steel, copper, titanium, or another highly corrosion resistant metal.

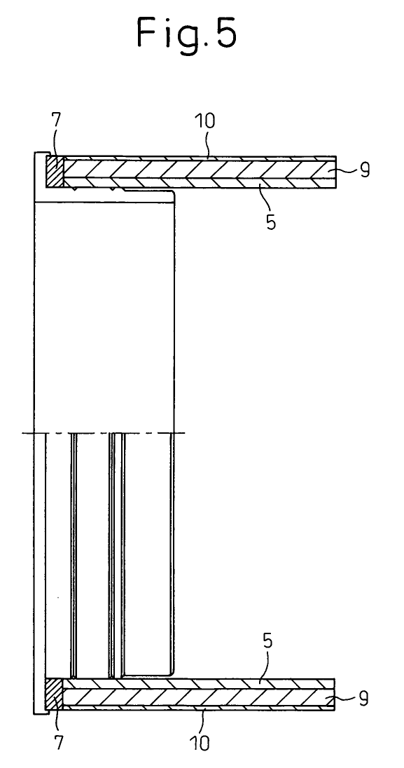

An example of attaching the above corrosive protection core to the end of the plastic lined steel pipe is shown in the cross-sectional view of FIG. 5. For attachment of the corrosive protection core, first the outer surface of the cylindrical part 1 and the inner surface of the flange part 2 to which the rubber ring 7 is bonded in advance of the corrosive protection core and the inner surface and end face of the end of the plastic lined steel pipe are degreased and cleaned. Next, the cylindrical part 1 of the corrosive protection core is inserted into the pipe end surface of the plastic lined steel pipe and hammered by a plastic hammer until the rubber ring 7 closely contacts the end face of the plastic lined steel pipe. Note that the rubber ring 7 improves the water-tightness between the flange part 2 and the end face of the plastic lined steel pipe and prevents contact and corrosion of different types of metal with the iron of the end face of the steel pipe when using a highly corrosion resistant metal as the material of the corrosive protection core. Therefore, it is also possible to provide a recess 8 at the inner surface of the flange part 2 so that the rubber ring 7 does not shift after attachment to the pipe end. Further, to improve the corrosion resistance of the end face of the plastic lined steel pipe, it is possible to degrease the plastic lined steel pipe, then coat the end face with a commercially available epoxy resin coating. Further, to improve the fitting strength of the corrosive protection core and plastic lined steel pipe, it is also possible to degrease the plastic lined steel pipe, then coat the inner surface and end face of the pipe end with a commercially available polyolefin plastic use adhesive.

If there is an epoxy primer layer between the steel pipe and the adhesive layer, a good waterproof bonding is obtained, so this is desirable. As the epoxy primer layer, a mixture formed by for example an epoxy, a pigment, an additive, and a curing agent (epoxy resin powder primer) is used. As the epoxy, for example, a diglycidyl ether of bisphenol A, a diglycidyl ether of bisphenol F, or a phenol novolac type or cresol novolac type glycidyl ether is used. These epoxies can be used alone or can be used mixed together according to the object. As the pigment, a fine powder of silica, barium sulfate, calcium carbonate, or other body pigment or titanium oxide, carbon black, or other coloring pigment is used. A good waterproof bonding is obtained when the amount added of these pigments is within a range of from 3 to 50 parts by weight with respect to 100 parts by weight of the epoxy. As the additive, use can be made of an acryl oligomer or fine powder silica.

As the curing agent, a dibasic acid such as dicyandiamide or decane dicarbonate, a hydrazine such as adipic acid dihydrazide, an acid anhydride such as tetrahydrophthalate anhydride, a phenol-based curing agent obtained by adding bisphenol A to a diglycidyl ether of bisphenol A, or an amine adduct obtained by adding diamide diphenylmethane to a diglycidyl ether of the bisphenol A can be used. If using a dibasic acid, hydrazine, or phenol-based curing agent for the curing agent, the amount of the curing agent is determined by the ratio between the equivalent weight of the epoxy and the equivalent weight of the active hydrogen of the curing agent. As the equivalent weight ratio, an 0.6 to 1.2 equivalent weight of the active hydrogen with respect to an 1.0 equivalent weight of epoxy is good.

If using dicyandiamide as the curing agent, in order to lower the curing temperature, a modified imidazole is added as the curing accelerator. As this modified imidazole, for example 2-methylimidazole, 2-phenylimidazole, etc. can be utilized. For the blending of the curing agent in this case, a good waterproof bonding is obtained if dicyandiamide is added in a range of from 3 to 10 parts by weight with respect to 100 parts by weight of the epoxy and the modified imidazole is added in a range of from 0.1 to 3 parts by weight with respect to 100 parts by weight of the epoxy. Similarly, even if using a phenol-based curing agent, a modified imidazole is effectively used as the curing accelerator. As a representative epoxy resin powder paint corresponding to the above composition, there is Powdax E (made by Nippon Paint Co. Ltd.)

The epoxy primer layer may be coated by electrostatic spray coating or fluid suction coating the epoxy primer layer on the inner surface of the steel pipe at room temperature to about 80° C., then heating steel pipe to cure the layer at about 140 to 220° C. by hot air heating, high frequency induction heating, etc. The thickness of this epoxy primer layer is preferably 40 to 600 μm. If the thickness is less than 40 μm, there is possibility that the thickness will become the film forming limit of the powder coating or less, so continuous coating will not be carried out and therefore the waterproof bond strength of the plastic lining layer will be lowered. Further, from the viewpoints of work efficiency and economy, the upper limit of the thickness is preferably about 600 μm.

It is also possible to provide the outer surface of the inner surface plastic lined steel pipe with a primary anti-rust coating, zinc rich paint coating, metal flame sprayed coating, or polyolefin coating in place of the galvanization. As the primary anti-rust coating, a general commercially available alkyd-based, epoxy-based paint, etc. is coated to a thickness of about 20 to 30 μm. As the zinc rich paint coating, a general commercially available organic or inorganic zinc rich paint etc. is coated to a thickness of about 65 to 85 μm. Further, in order to improve the corrosion resistance, it is also possible to coat a commercially available clear paint, white rust prevention paint, or the like according to need after coating the zinc rich paint. As the metal flame sprayed coating, for example, a metal sacrificially corroding the iron, that is, zinc, aluminum, an zinc-aluminum alloy, or an aluminum-magnesium alloy is used. For coating the metal flame sprayed coating, the outer surface of the pipe end is degreased and then blasted to clean it. After this, the outer surface of the steel pipe is coated with a metal flame sprayed coating by gas flame spraying, electric arc flame spraying, or electric plasma flame spraying. The thickness of the metal flame sprayed coating should be 100 to 400 μm or so. If the thickness if less than 100 μm, hot dip galvanization reduces the corrosion resistance. Further, from the viewpoints of the work efficiency and economicalness, the upper limit of the thickness should be 400 μm. Further, to improve the anti-corrosion property, it is also possible to coat a white rust prevention agent or a hole sealing agent etc. in accordance with need after coating the metal flame sprayed coating. If using a polyolefin coating, first the outer surface of the steel pipe is degreased and blasted or pickled to clean it. Thereafter, the adhesive and the polyolefin resin are sequentially coated.

As the adhesive, a material comprised of one or two or more of a maleic anhydride-modified polyolefin, itaconic anhydride-modified polyolefin, ethylene/maleic anhydride copolymer, ethylene/maleic anhydride/acrylate copolymer, ethylene/maleic anhydride/acrylate ester copolymer, ethylene/acrylate copolymer, ethylene/acrylate ester copolymer, ethylene/methacrylate copolymer, ethylene/vinyl acetate copolymer, and ionomer is used. As the ratio of addition of the maleic anhydride, a good bond strength is obtained when it is added within the range of from 0.05 to 0.5 wt %.

This adhesive is coated by extrusion onto the outer surface of the steel pipe by using a round die or T-die. When the thickness of this adhesive is about 80 to 400 μm, a good bond strength is obtained.

As the polyolefin resin, an ethylene homopolymer or an ethylene/α-olefin copolymer obtained by copolymerizing ethylene and propylene, 1-butene, 1-hexene, 1-octene, or another α-olefin or a mixture of the same including, according to need, an additive such as an antioxidant, UV absorbent, fire retardant, pigment, filler, lubricant, or antistatic agent and another resin is used.

These polyolefin resins are coated by extrusion onto the outer surface of a steel pipe coated with an adhesive by using a round die or T-die, but the method of using a two-layer round die or two-layer T die and coextruding the adhesive and the polyolefin resin for coating can also be used. When the thickness of this polyolefin resin is about 0.3 to 10 μm, a good anti-corrosion property is obtained.

Further, when there is a chemical conversion coating or epoxy primer between the steel pipe and the adhesive, a good waterproof bonding is obtained, so this is desirable. As the chemical conversion solution, for example, an aqueous solution (chromate treatment solution) obtained by partially reducing an aqueous solution of chromate anhydride alone or a mixed aqueous solution of this with phosphoric acid by an organic reducing agent to create a mixture of hexavalent chrome and trivalent chrome, then adding silica particles alone or in a mixture with a silane coupling agent is used. In the coating of the chemical conversion coating, the steel pipe may be coated with the above chemical conversion solution by drop spreading, spraying, or dipping, then heated and dried by high frequency induction heating, hot air heating, etc. The amount of deposition of this chemical conversion coating is preferably about 100 to 700 mg/m² as total chrome. If the deposition amount thereof is less than 100 mg/m² or over 700 mg/m², the waterproof bond strength of the polyolefin coating will be lowered.

As the epoxy primer, for example an epoxy resin powder primer is used. The epoxy primer may be coated by pre-heating the steel pipe given the chemical conversion coating by high frequency induction heating or hot air heating, then electrostatic spray coating or fluid suction coating the epoxy primer layer on the surface. The thickness of this epoxy primer is preferably 40 to 600 μm. If the thickness is less than 40 μm, the waterproof bond strength of the polyolefin coating is lowered. Further, from the viewpoints of the work efficiency and economy, the upper limit of the thickness is preferably about 600 μm.

According to the present invention, by treating the steel pipe for substrate treatment by refining the grains and providing a phosphate chemical conversion coating strengthened in bond strength so as to prevent the chemical conversion coating from failing to withstand the increase in shrinkage and peeling force of the inner surface plastic lining layer due to the drop in air temperature in the winter season in outdoor use in cold regions and ending up breaking and the plastic lining layer at the inner surface of the end from peeling off, providing circumferential grooves at the outer surface of the cylindrical part of the corrosive protection core so as to absorb the expansion of the inner surface plastic lining layer due to the rise in air temperature in the summer season and prevent the corrosive protection core from ending up being pushed out, and having the expanded inner surface plastic lining layer project out and constrain the corrosive protection core so as to prevent the flow of water from causing the corrosive protection core from detaching from the end even when the level of the air temperature causes the inner surface plastic lining layer to expand and contract and therefore the stress to be greatly eased and the fitting strength of the corrosive protection core drops, a plastic lined pipe with an end corrosive protection core used for piping etc. for snow melting, water supply, air-conditioning, firefighting, drainage, etc. when an end corrosive protection coupling cannot be used which is excellent in bonding between the steel pipe and the end inner surface plastic lining layer and fastenability of the corrosive protection core and end inner surface plastic lining layer over a long period can be provided.

The present invention will be explained in detail next based on examples.

### EXAMPLE 1

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m², and the average grain size thereof was about 5 μm. Next, using a two-layer round die, when shaping a polyethylene plastic pipe (melt start temperature of 120° C.) having an outside diameter of 108.2 mm, a thickness of 2.0 mm, and a length of 5940 mm, an adhesive made of a maleic anhydride-modified polyethylene (melt end temperature: 100° C.) was coated on the outer surface by coextrusion so as to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment agent by the drop spread method, heated to a surface temperature of the steel pipe of 115° C. by high frequency induction heating to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 2

A steel pipe hot dip galvanized at its outer surface and having an outside diameter of 119.7 mm, a thickness of 4.15 mm, and a length of 5900 mm was degreased by a commercially available alkali degreasing agent and pickled to remove the rust at its inner surface, then the steel pipe was sequentially filled with a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m², and the average grain size thereof was about 5 μm. Next, the inner surface of the steel pipe was coated at room temperature by an epoxy resin powder prime (Powdax E made by Nippon Paint Co. Ltd.) by electrostatic spraying, and the result was heated to 155° C. in a hot air heating furnace to form an epoxy primer layer. The thickness of the epoxy primer layer was 100 μm. Further, using a two-layer round die, when shaping a polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 3

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined pipe was degreased by a commercially available alkali degreasing agent, grit blasted to remove the rust, then coated with a commercially available alkyd-based paint to a thickness of 25 μm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 4

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, an epoxy resin powder primer (Powdax E made by Nippon Paint Co. Ltd.) was coated on the inner surface of the steel pipe at room temperature by electrostatic spraying, and the result was heated to 155° C. in a hot air heating furnace to form an epoxy primer layer. The thickness of the epoxy primer layer was 100 μm. Further, using a two-layer round die, when shaping a polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 am.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 5

A steel pipe having an outside diameter of 119.7 mm, a thickness of 4.15 mm, and a length of 5900 mm was degreased by a commercially available alkali degreasing agent and pickled to remove the rust, then the steel pipe was dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, an epoxy resin powder primer (Powdax E made by Nippon Paint Co. Ltd.) was coated on the inner surface of the steel pipe at room temperature by electrostatic spraying, then the result was heated to 155° C. in a hot air heating furnace to form an epoxy primer layer. The thickness of the epoxy primer layer was 100 μm. Further, using a two-layer round die, when shaping a polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of the inner surface plastic lined pipe was degreased by a commercially available alkali degreasing agent, grit blasted to remove the rust, then flame sprayed with a zinc (85%) and aluminum (15%) alloy by the electric arc method to a thickness of 100 μm and further coated with a white rust prevention agent to a thickness of 10 μm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 6

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated by high frequency induction heating to a surface temperature of the steel pipe of 115° C. to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plastic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 7

Except for using as a groove sectional shape of the corrosive protection core the one of FIG. 3 (width 1 mm and depth 1 mm), the same procedure was used as in Example 6 to obtain a plastic lined steel pipe with an end corrosive protection core.

### EXAMPLE 8

Except for using as a groove sectional shape of the corrosive protection core the one of FIG. 4 (width 1 mm and depth 1 mm), the same procedure was used as in Example 6 to obtain a plastic lined steel pipe with an end corrosive protection core.

### EXAMPLE 9

Except for using copper as the material of the corrosive protection core, the same procedure was used as in Example 6 to obtain a plastic lined steel pipe with an end corrosive protection core.

### EXAMPLE 10

Except for using titanium as the material of the corrosive protection core, the same procedure was used as in Example 6 to obtain a plastic lined steel pipe with an end corrosive protection core.

### EXAMPLE 11

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, using a two-layer round die, when shaping a polyethylene plastic pipe having an outside diameter of 108.2 mm, a thickness of 2.0 mm, and a length of 5940 mm (melt start temperature of 155° C.), an adhesive made of a maleic anhydride-modified polypropylene (melt end temperature: 145° C.) was coated on the outer surface by coextrusion to form an adhesive layer. The thickness of the adhesive layer was 200 μm.

Thereafter, the polypropylene plastic pipe was inserted into the steel pipe and the steel pipe was roll drawn so that the outside diameter of the polypropylene plastic pipe was reduced by 2.2%, whereby the polypropylene plastic pipe was made to closely contact the inner surface of the steel pipe, then the result was heated to 150° C. in a hot air heating furnace. The part of the polypropylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated by high frequency induction heating to a surface temperature of the steel pipe of 115° C. to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 12

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, the inner surface of the steel pipe was coated at room temperature with an epoxy resin powder primer (Powdax E made by Nippon Paint Co. Ltd.) by electrostatic spraying, then the result was heated to 155° C. in a hot air heating furnace to form an epoxy primer layer. The thickness of the epoxy primer layer was 100 μm. Further, using a two-layer round die, when shaping a polypropylene plastic pipe having an outside diameter of 108.2 mm, a thickness of 2.0 mm, and a length of 5940 mm (melt start temperature of 155° C.), an adhesive made of a maleic anhydride-modified polypropylene (melt end temperature: 145° C.) was coated on the outer surface by coextrusion to form an adhesive layer. The thickness of the adhesive layer was 200 μm.

Thereafter, the polypropylene plastic pipe was inserted into the steel pipe and the steel pipe was roll drawn so that the outside diameter of the polypropylene plastic pipe was reduced by 2.2%, whereby the polypropylene plastic pipe was made to closely contact the inner surface of the steel pipe, then the result was heated to 150° C. in a hot air heating furnace. The part of the polypropylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated to a surface temperature of the steel pipe of 115° C. by high frequency induction heating to form a chemical conversion coating. The amount of deposition of the chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 13

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, using a two-layer round die, when shaping a cross-linked polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 2.2%, whereby the cross-linked polyethylene plastic pipe was made to closely contact the inner surface of the steel pipe, then the result was heated to 115° C. in a hot air heating furnace. The part of the cross-linked polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated to a surface temperature of the steel pipe of 115° C. by high frequency induction heating to form a chemical conversion coating. The amount of deposition of the chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### EXAMPLE 14

A steel pipe having an outside diameter of 119.7 mm, a thickness of 4.15 mm, and a length of 5900 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, the inner surface of the steel pipe was coated at room temperature with an epoxy resin powder primer (Powdax E made by Nippon Paint Co. Ltd.) by electrostatic spraying, then the result was heated to 155° C. in a hot air heating furnace to form an epoxy primer layer. The thickness of the epoxy primer layer was 100 μm. Further, using a two-layer round die, when shaping a cross-linked polyethylene plastic pipe having an outside diameter of 108.2 mm, a thickness of 2.0 mm, and a length of 5940 mm (melt start temperature of 120° C.), an adhesive made of a maleic anhydride-modified polypropylene (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the polyethylene plastic pipe was reduced by 2.2%, whereby the cross-linked polyethylene plastic pipe was made to closely contact the inner surface of the steel pipe, then the result was heated to 115° C. in a hot air heating furnace. The part of the cross-linked polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated to a surface temperature of the steel pipe of 115° C. by high frequency induction heating to form a chemical conversion coating. The amount of deposition of the chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### COMPARATIVE EXAMPLE 1

A steel pipe having an outside diameter of 119.7 mm, a thickness of 4.15 mm, and a length of 5900 mm was degreased by a commercially available alkali degreasing agent and pickled to remove the rust, then the steel pipe was dipped in a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 15 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a polyethylene plastic pipe of an outside diameter of 108.2 mm, a thickness of 2.0 mm, and a length of 5940 mm (melt start temperature: 120° C.), an adhesive made of a maleic anhydride-modified polyethylene (melt end temperature: 100° C.) was coated on the outer surface by co-extrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment agent by the drop spread method, heated to a surface temperature of the steel pipe of 115° C. by high frequency induction heating to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### COMPARATIVE EXAMPLE 2

A steel pipe having an outside diameter of 119.7 mm, a thickness of 4.15 mm, and a length of 5900 mm was degreased by a commercially available alkali degreasing agent and pickled to remove the rust at its inner surface, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 2.2%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated by high frequency induction heating to a surface temperature of the steel pipe of 115° C. to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### COMPARATIVE EXAMPLE 3

A steel pipe having an outside diameter of 119.7 mm, a thickness of 4.15 mm, and a length of 5900 mm was degreased by a commercially available alkali degreasing agent and pickled to remove the rust at its inner surface, then the steel pipe was dipped in a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 15 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a polypropylene plastic pipe having an outside diameter of 108.2 mm, a thickness of 2.0 mm, and a length of 5940 mm (melt start temperature of 155° C.), an adhesive made of a maleic anhydride-modified polypropylene (melt end temperature: 145° C.) was coated on the outer surface by coextrusion to form an adhesive layer. The thickness of the adhesive layer was 200 μm.

Thereafter, the polypropylene plastic pipe was inserted into the steel pipe and the steel pipe was roll drawn so that the outside diameter of the polypropylene plastic pipe was reduced by 2.2%, whereby the polypropylene plastic pipe was made to closely contact the inner surface of the steel pipe, then the result was heated to 150° C. in a hot air heating furnace. The part of the polypropylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated by high frequency induction heating to a surface temperature of the steel pipe of 115° C. to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### COMPARATIVE EXAMPLE 4

A steel pipe having an outside diameter of 119.7 mm, a thickness of 4.15 mm, and a length of 5900 mm was degreased by a commercially available alkali degreasing agent and pickled to remove the rust at its inner surface, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a polypropylene plastic pipe having an outside diameter of 108.2 mm, a thickness of 2.0 mm, and a length of 5940 mm (melt start temperature of 155° C.), an adhesive made of a maleic anhydride-modified polypropylene (melt end temperature: 145° C.) was coated on the outer surface by coextrusion to form an adhesive layer. The thickness of the adhesive layer was 200 μm.

Thereafter, the polypropylene plastic pipe was inserted into the steel pipe and the steel pipe was roll drawn so that the outside diameter of the polyproylene plastic pipe was reduced by 2.2%, whereby the polypropylene plastic pipe was made to closely contact the inner surface of the steel pipe, then the result was heated to 150° C. in a hot air heating furnace. The part of the polypropylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated by high frequency induction heating to a surface temperature of the steel pipe of 115° C. to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### COMPARATIVE EXAMPLE 5

A steel pipe having an outside diameter of 119.7 mm, a thickness of 4.15 mm, and a length of 5900 mm was degreased by a commercially available alkali degreasing agent and pickled to remove the rust at its inner surface, then the steel pipe was dipped in a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 15 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a cross-linked polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 2.2%, whereby the cross-linked polyethylene plastic pipe was made to closely contact the inner surface of the steel pipe, then the result was heated to 115° C. in a hot air heating furnace. The part of the cross-linked polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated by high frequency induction heating to a surface temperature of the steel pipe of 115° C. to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and circumferentially at its outer surface with two grooves (width 1 mm, depth 1 mm) of the sectional shapes shown in FIG. 2 and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

### COMPARATIVE EXAMPLE 6

A steel pipe having an outside diameter of 119.7 mm, a thickness of 4.15 mm, and a length of 5900 mm was degreased by a commercially available alkali degreasing agent and pickled to remove the rust at its inner surface, then the steel pipe was sequentially dipped in a treatment solution obtained by dispersing titanium colloid in water (Prepalene Z made by Nihon Parkerizing Co. Ltd.) and a calcium-modified zinc phosphate treatment solution (Palbond P made by Nihon Parkerizing Co. Ltd.) and dried by hot air heating to form a chemical conversion coating. The amount of deposition of the chemical conversion coating was 4 g/m². The average grain size was 5 μm or so. Next, the inner surface of the steel pipe was coated at room temperature with an epoxy resin powder primer (Powdax E made by Nippon Paint Co. Ltd.) by electrostatic spraying, then heated to 155° C. in a hot air heating furnace to form an epoxy primer layer. The thickness of the epoxy primer layer was 100 μm. Further, using a two-layer round die, when shaping a cross-linked polyethylene plastic pipe having an outside diameter of 108.2 mm, a thickness of 2.0 mm, and a length of 5940 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 2.2%, whereby the polyethylene plastic pipe was made to closely contact the inner surface of the steel pipe, then the result was heated to 115° C. in a hot air heating furnace. The part of the cross-linked polyethylene plastic pipe protruding from the end portion of the steel pipe was cut off.

The outer surface of this inner surface plastic lined pipe was degreased by a commercially available alkali degreasing agent, grit blasted to remove the rust, then coated with a chromate treatment solution by the drop spread method and heated by high frequency induction heating to a surface temperature of the steel pipe of 115° C. to form a chemical conversion coating. The amount of deposition of this chemical conversion coating was 200 mg/m² as total chrome. Right after that, a two-layer round die was used to coextrude a maleic-anhydride modified polyethylene adhesive and polyethylene resin to form a coating. The thicknesses of the maleic-anhydride modified polyethylene adhesive and polyethylene resin were 200 μm and 0.5 mm.

As the corrosive protection core, use was made of a core made of stainless steel formed by a cylindrical part (length 25.5 mm, thickness 3 mm) provided at its front end with a guide part (length 10 mm) having an outside diameter smaller than the inside diameter of the plastic lined steel pipe and a flange part (thickness 3 mm) having an outside diameter equal to the outside diameter of the plastic lined steel plate and provided at its inner surface with a recess (depth 0.5 mm) to prevent shifting of a rubber ring.

The outer surface of the cylindrical part of this stainless steel corrosive protection core, the inner surface of the flange part to which a styrene-butadiene ring (thickness 1 mm) is closely fit in advance, and the inside surface and end faces of the plsatic lined steel pipe were degreased by acetone, the end inside surface and end faces were successively coated with a commercially available polyolefin resin use adhesive, then the cylindrical part of the stainless steel corrosive protection core was inserted into the end inner surface of the plastic lined steel pipe and the core was hammered by a plastic hammer until the styrene-butadiene rubber ring closely contacted the end face of the plastic lined steel pipe.

The plastic lined pipes of Examples 1 to 14 and Comparative Examples 1 to 6 were subjected to cooling/heating tests envisioning outdoor use at cold locations and reproducing the drop in air temperature in the winter season and the rise in air temperature at the summer season. The cooling/heating tests were carried out by placing the produced plastic lined steel pipes with end corrosive protection cores in an isothermal chamber and cooling them so that the temperature became −20° C., then heating them to 60° C. This operation was repeated 1500 times, then the plastic lining layers and corrosive protection cores at the end inner surfaces were observed. The conditions and results of observation of the examples are shown in Tables 1 and 2.

In each of Examples 1 to 14, no peeling occurred at the plastic lining layer of the end inner surface and the corrosive protection cores remained fastened to the pipe ends, but in Comparative Examples 1, 3, and 5, the corrosive protection cores remained fastened to the pipe ends, but peeling occurred at the plastic lining layers of the end inner surfaces, while in Comparative Examples 2, 4, and 6, the plastic lining layers of the end inner surfaces did not peel off, but the corrosive protection cores were pushed off from the pipe ends and ended up detaching.

Further, the plastic lined steel pipes with end corrosive protection cores of the examples and comparative examples were subjected to running water tests envisioning outdoor use at cold locations and reproducing the drop in air temperature in the winter season and the rise in air temperature at the summer season. The running water tests were carried out by connecting the produced plastic lined steel pipes with end corrosive protection cores by H-couplings with water sprinklers used for snow removal pipes and alternately running 5° C. cold water and 60° C. hot water through them until reaching the respective temperatures (no sprinkling of water). This operation was repeated 3000 times, then the plastic lining layers and corrosive protection cores at the end inner surfaces were observed. The results of observation are also shown in Tables 1 and 2.

In each of Examples 1 to 14, no peeling occurred at the plastic lining layer of the end inner surface and the corrosive protection cores remained fastened to the pipe ends, but in Comparative Examples 1, 3, and 5, the corrosive protection cores remained fastened to the pipe ends, but peeling occurred at the plastic lining layers of the end inner surfaces, while in Comparative Examples 2, 4, and 6, the running water caused the corrosive protection cores to detach from the pipe ends, the iron at the end faces of the steel pipes corroded, and the plastic lining layers at the end inner surfaces partially peeled off.

TABLE 1

| | | | | | | | Condition of end inner surface | |
|---|---|---|---|---|---|---|---|---|
| | | | | | Corrosive protection | | plastic lining layer (upper row) | |
| | | | | | core | | Condition of corrosive | |
| | Steel pipe inner surface | | | | | Groove | protection core (bottom row) | |
| | Plastic | | | Steel pipe Outer | | sectional | Cooling/heat- | Running water |
| Ex. | layer | Adhesive layer | Substrate treatment etc. | surface | Material | shape | ing cycle test | test |
| Ex. 1 | Poly- | Maleic-anhydride | Calcium-modified zinc | Polyethylene | Stainless | | No peeling | No peeling |
| | ethylene | modified | phosphate* | coating | steel | | Fastened to end | Fastened to end |
| | | polyethylene | | | | | | |
| Ex. 2 | Poly- | Maleic- | Calcium-modified zinc | Hot dip galvani- | Stainless | | No peeling | No peeling |
| | ethylene | anhydride modified | phosphate* + epoxy resin | zation | steel | | Fastened to end | Fastened to end |
| | | polyethylene | powder primer | | | | | |
| Ex. 3 | Poly- | Maleic- | Calcium-modified zinc | Primary anti- | Stainless | | No peeling | No peeling |
| | ethylene | anhydride modified | phosphate* + epoxy resin | rust coating | steel | | Fastened to end | Fastened to end |
| | | polyethylene | powder primer | | | | | |
| Ex. 4 | Poly- | Maleic- | Calcium-modified zinc | Zinc-rich paint | Stainless | | No peeling | No peeling |
| | ethylene | anhydride modified | phosphate* + epoxy resin | coating | steel | | Fastened to end | Fastened to end |
| | | polyethylene | powder primer | | | | | |
| Ex. 5 | Poly- | Maleic- | Calcium-modified zinc | Zinc-aluminum | Stainless | | No peeling | No peeling |
| | ethylene | anhydride modified | phosphate* + epoxy resin | alloy flame | steel | | Fastened to end | Fastened to end |
| | | polyethylene | powder primer | spraying | | | | |
| Ex. 6 | Poly- | Maleic- | Calcium-modified zinc | Polyethylene | Stainless | | No peeling | No peeling |
| | ethylene | anhydride modified | phosphate* + epoxy resin | coating | steel | | Fastened to end | Fastened to end |
| | | polyethylene | powder primer | | | | | |
| Ex. 7 | Poly- | Maleic- | Calcium-modified zinc | Polyethylene | Stainless | | No peeling | No peeling |
| | ethylene | anhydride modified | phosphate* + epoxy resin | coating | steel | | Fastened to end | Fastened to end |
| | | polyethylene | powder primer | | | | | |
| Ex. 8 | Poly- | Maleic- | Calcium-modified zinc | Polyethylene | Stainless | | No peeling | No peeling |
| | ethylene | anhydride modified | phosphate* + epoxy resin | coating | steel | | Fastened to end | Fastened to end |
| | | polyethylene | powder primer | | | | | |
| Ex. 9 | Poly- | Maleic- | Calcium-modified zinc | Polyethylene | Copper | | No peeling | No peeling |
| | ethylene | anhydride modified | phosphate* + epoxy resin | coating | | | Fastened to end | Fastened to end |
| | | polyethylene | powder primer | | | | | |
| Ex. 10 | Poly- | Maleic- | Calcium-modified zinc | Polyethylene | Titanium | | No peeling | No peeling |
| | ethylene | anhydride modified | phosphate* + epoxy resin | coating | | | Fastened to end | Fastened to end |
| | | polyethylene | powder primer | | | | | |

*Grain refinement treatment

TABLE 2

| | | | | | | | Condition of end inner surface | |
|---|---|---|---|---|---|---|---|---|
| | | | | | Corrosive protection | | plastic lining layer (upper row) | |
| | | | | | core | | Condition of corrosive | |
| | Steel pipe inner surface | | | | | Groove | protection core (bottom row) | |
| | Plastic | | | Steel pipe Outer | | sectional | Cooling/heat- | Running water |
| Ex. | layer | Adhesive layer | Substrate treatment etc. | surface | Material | shape | ing cycle test | test |
| Ex. 11 | Poly- | Maleic-anhydride | Calcium-modified zinc | Polyethylene | Stainless | | No peeling | No peeling |
| | propylene | modified | phosphate* | coating | steel | | Fastened to end | Fastened to end |
| | | polypropylene | | | | | | |
| Ex. 12 | Poly- | Maleic- | Calcium-modified zinc | Polyethylene | Stainless | | No peeling | No peeling |
| | propylene | anhydride modified | phosphate* + epoxy resin | coating | steel | | Fastened to end | Fastened to end |
| | | polypropylene | powder primer | | | | | |
| Ex. 13 | Cross- | Maleic- | Calcium-modified zinc | Polyethylene | Stainless | | No peeling | No peeling |
| | linked | anhydride modified | phosphate* | coating | steel | | Fastened to end | Fastened to end |
| | poly- | polyethylene | | | | | | |
| | ethylene | | | | | | | |
| Ex. 14 | Cross- | Maleic- | Calcium-modified zinc | Polyethylene | Stainless | | No peeling | No peeling |
| | linked | anhydride modified | phosphate* + epoxy resin | coating | steel | | Fastened to end | Fastened to end |
| | poly- | polyethylene | powder primer | | | | | |
| | ethylene | | | | | | | |
| Comp. | Poly- | Maleic- | Calcium-modified zinc | Polyethylene | Stainless | | Peeling | Peeling |
| Ex. 1 | ethylene | anhydride modified | phosphate** + epoxy resin | coating | steel | | Fastened to end | Fastened to end |
| | | polyethylene | powder primer | | | | | |
| Comp. | Poly- | Maleic- | Calcium-modified zinc | Polyethylene | Stainless | — | No peeling | Partial peeling |
| Ex. 2 | ethylene | anhydride modified | phosphate* + epoxy resin | coating | steel | | Detaches by hand | Detaches from |
| | | polyethylene | powder primer | | | | | end |
| Comp. | Poly- | Maleic- | Calcium-modified zinc | Polyethylene | Stainless | | Peeling | Peeling |
| Ex. 3 | propylene | anhydride modified | phosphate** + epoxy resin | coating | steel | | Fastened to end | Fastened to end |
| | | polypropylene | powder primer | | | | | |
| Comp. | Poly- | Maleic- | Calcium-modified zinc | Polyethylene | Stainless | — | No peeling | Partial peeling |
| Ex. 4 | propylene | anhydride modified | phosphate* + epoxy resin | coating | steel | | Detaches by hand | Detaches from |
| | | polypropylene | powder primer | | | | | end |
| Comp. | Cross- | Maleic- | Calcium-modified zinc | Polyethylene | Stainless | | Peeling | Peeling |
| Ex. 5 | linked | anhydride modified | phosphate** + epoxy resin | coating | steel | | Fastened to end | Fastened to end |
| | poly- | polyethylene | powder primer | | | | | |
| | ethylene | | | | | | | |
| Comp. | Cross- | Maleic- | Calcium-modified zinc | Polyethylene | Stainless | — | No peeling | Partial peeling |
| Ex. 6 | linked | anhydride modified | phosphate* + epoxy resin | coating | steel | | Detaches by hand | Detaches from |
| | poly- | polyethylene | powder primer | | | | | end |
| | ethylene | | | | | | | |

*Grain refinement treatment,
**No grain refinement treatment

As clearly understand from the above Tables, the plastic lined steel pipes with end corrosive protection cores of the present invention are excellent in bonding between the steel pipe and the end inner surface plastic lining layer over a long period and fastenability between the corrosive protection core and end inner surface plastic lining layer over a long period even when the contraction and peeling force of the inner surface plastic lining layer are large due to the drop in air temperature in the winter season in outdoor use in cold locations and further when the level of air temperature causes the inner surface plastic lining layer to expand and contract and therefore the stress to be greatly eased and the fitting strength of the corrosive protection core to fall.

1. A plastic lined pipe with an end corrosive protection core used connected by a coupling not having an end corrosive protection function, characterized by having an adhesive layer on an inner surface of a steel pipe or a steel pipe galvanized on its outer surface, having a polyolefin plastic layer or cross-linked polyolefin plastic layer on its further inner side, said steel pipe being a steel pipe given substrate treatment on its inner surface in advance, said substrate treatment comprising forming a phosphate chemical conversion coating treated for grain refinement, and provided with a corrosive protection core at the end.

2. A plastic lined pipe with an end corrosive protection core as set forth in claim 1, wherein said corrosive protection core is formed by a cylindrical part having dimensions and rigidity enabling strong fitting to the end inner surface of the plastic lined steel pipe and a flange part having a shape and rigidity enabling attachment, then close fitting to the end while completely covering the end face of the plastic lined steel pipe, the outer surface of the cylindrical part being provided with circumferential grooves.

3. A plastic lined pipe as set forth in claim 1 wherein the material of said corrosive protection core is a high corrosion resistance metal, and the inner surface of the flange part of the corrosive protection core has a rubber ring closely fit to it.

4. A plastic lined pipe with an end corrosive protection core as set forth in claim 1, wherein an epoxy primer layer is provided between said steel pipe and said adhesive layer.

5. A plastic lined pipe with an end corrosive protection core as set forth in claim 1, wherein a primary anti-rust coating, a zinc rich paint coating, a metal flame sprayed coating, or a polyolefin coating is provided on the outer surface of said plastic lined pipe instead of galvanization.

6. A method for producing a plastic lined pipe as set forth in claim 1, comprising, when producing said plastic lined pipe, applying substrate treatment to a steel pipe or applying substrate treatment to a steel pipe, then applying an epoxy primer layer, inserting a polyolefin plastic pipe or cross-linked polyolefin plastic pipe having an outside diameter smaller than the inside diameter of the steel pipe and having an adhesive layer on its outer surface into said steel pipe, drawing the steel pipe so as to make the polyolefin plastic pipe or cross-linked polyolefin plastic pipe come in close contact with the inner surface of the steel pipe, then heating the result at a temperature not less than a melt end temperature of the adhesive layer and less than a melt start temperature of the polyolefin plastic pipe or cross-linked polyolefin plastic pipe.

7. A method for producing a plastic lined pipe with an end corrosive protection core as set forth in claim 6 further comprising, when drawing said steel pipe, drawing the steel pipe so that the outside diameter of the polyolefin plastic pipe or cross-linked polyolefin plastic pipe is reduced by 0.5 to 10%.
